(19) United States
(12) Patent Application Publication
(10) Pub. No.: US 2024/0404171 A1
(43) Pub. Date: Dec. 5, 2024

(54) SYNTHESIZED HAND TEXTURE

(71) Applicant: Apple Inc., Cupertino, CA (US)

(72) Inventors: Chong Li, Redmond, WA (US); Borja Morales Hernando, Sunnyvale, CA (US); Michael S Hutchinson, San Carlos, CA (US)

(21) Appl. No.: 18/669,956

(22) Filed: May 21, 2024

Related U.S. Application Data
(60) Provisional application No. 63/470,255, filed on Jun. 1, 2023.

(51) Int. Cl. G06T 15/04

(52) U.S. Cl. CPC G06T 15/04

(57) ABSTRACT

Various implementations disclosed herein include devices, systems, and methods that provide a matching skin tone between the hands and the face of a three-dimensional (3D) user representation. For example, a process may obtain at least two skin tones corresponding to colors representing at least two different portions of a hand of a user. In response, a hand texture representing a spatial arrangement of color representing an appearance of the hand is determined. The hand texture may be determined based on the at least two skin tones and hand texture sample data. The process may further include determining a hand structure associated with physical attributes of the hand and the hand structure and the hand texture may be provided for use in generating a 3D representation of the hand.

### CROSS-REFERENCE TO RELATED APPLICATIONS

This application claims the benefit of U.S. Provisional Application Ser. No. 63/470,255 filed Jun. 1, 2023, which is incorporated herein in its entirety.

### TECHNICAL FIELD

The present disclosure generally relates to systems, methods, and devices that provide a three-dimensional (3D) representation of a user.

### BACKGROUND

Existing 3D representations enable viewing of user representations. Existing 3D representation presentation techniques may not provide a uniform texture, for example, with respect to adequately producing a 3D representation comprising a hand texture/tone that is consistent with facial skin tones and accurate with respect to a skin tone of a palm and a back side of a hand.

### SUMMARY

Various implementations disclosed herein include devices, systems, and methods that create a hand texture (e.g., a grid of pixel values representing the appearance of different portions of a user hand) for use in providing a 3D user representation of a user's hand. The hand texture may be determined using info about both the user's face and hands (e.g., hand back & palm) and sample hand textures. Using both face and hands input may help ensure that the hand texture is consistent with the face and accurate with respect to the palm. Using sample hand textures may preserve privacy, enable efficiency, and compensate for missing, occluded, and/or inaccurate hand data. A hand texture process may identify a relatively small number (e.g., 2, 3, 4) skin tones (e.g., color(s) representing different surfaces of a user's skin, such as a hand back and palm) and use those skin tones to generate, lookup, or interpolate a texture based on a collection of sample hand textures.

Some implementations determine a hand texture (or tone) during an enrollment process for use in providing an accurate 3D user representation of a hand of a user. A hand texture may be determined based on data (e.g., images) associated with the user's face and hands (e.g., a back (dorsal) side of a hand and a palm side of the hand) in combination with sample hand textures (e.g., real hand scans from multiple differing individuals). Determining a hand texture via analysis of a texture or tone of a face and hands of a user (with respect to generating a user representation such as, inter alia, an avatar) may ensure that a hand texture is consistent with respect to facial skin tones and accurate with respect to a skin tone of a palm of a user thereby reducing or eliminating a perception that the hand(s) and face of the user do not belong to a same person. Additionally, determining a hand texture via analysis of a texture or tone of a face and hands of a user may account for differing lighting conditions, present during an enrollment process, resulting in hand textures comprising inaccurate skin tones. Likewise, using sample hand textures in combination with analysis of a texture or tone of a face and hands of a user (to determine a hand texture) may preserve user privacy (e.g., by removing identifying user features such as, inter alia, scars, tattoos, fingerprint patterns, etc.), enable efficiency, and compensate for missing, occluded, and/or inaccurate hand enrollment data.

Various implementations may identify one or more skin tones from different surfaces of a user. For example, two (e.g., a set) skin tones may include a first skin tone representing a back (dorsal) side of a hand and a second skin tone representing a palm side of the hand. The two skin tones may be used to generate and/or lookup a texture based on sample hand textures via any type of statistical process 210 (e.g., numerical optimization). Alternatively, the two skin tones may be used to generate and/or lookup a texture based on sample hand textures via an interpolation process. Various implementations generate the set of skin tones based on a patch of facial texture from delighted face enrollment data and hand enrollment images.

In some implementations, any type of statistical process that captures the distribution of a hand texture (e.g., a principal component analysis (PCA), a variational auto encoder (VAE), etc.) may be used may be used to compress sample hand textures and remove details (of the sample hand textures) to preserve sample data privacy and reduce storage requirements for the sample hand textures.

A hand structure associated with physical attributes (e.g., a bone length) of hand may be provided in combination with the hand texture to generate a 3D representation of a hand.

Various implementations determine a hand texture and hand structure during an enrollment process. In this instance, the hand texture and hand structure may be stored for later use such as, inter alia, during live communication session.

During display of a user hand representation, a generated hand texture's pixel values may be mapped to vertices of a 3D hand mesh (which may be based on the hand's current 3D position/configuration) to provide an appearance of the 3D user hand representation. The 3D hand mesh may be based on a current 3D position and/or configuration of a hand.

Various implementations enable a 3D hand(s) representation to be rendered concurrently with (and positioned with respect to) a 3D head and/or face representation. In some implementations, a single process (e.g., machine learning (ML) model) is used to produce a representation of both the hand(s) and head/face.

In some implementations, a device has a processor (e.g., one or more processors) that executes instructions stored in a non-transitory computer-readable medium to perform a method. The method performs one or more steps or processes. In some implementations, at least two skin tones are obtained. The at least two skin tones correspond to color(s) s representing at least two different portions of a hand of a user. In some implementations, a hand texture representing a spatial arrangement of color representing an appearance of the hand is determined. The hand texture may be determined based on the at least two skin tones and hand texture sample data corresponding to sample hand textures corresponding to at least some individuals other than the use. In some implementations, a hand structure associated with physical attributes of the hand is determined. In some implementations, the hand structure and the hand texture are provided for use in generating a 3D representation of the hand.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates an example environment of a real-world environment including a device with a display, in accordance with some implementations.

FIG. 2 illustrates an example system that uses a skin tone of a palm side and a skin tone of a back side of a hand of a user in combination with delighted facial texture and sample hand textures to generate a synthesized hand texture, in accordance with some implementations.

FIG. 3 illustrates an example process using a neural network to estimate a nominal skin tone of a hand(s) of a user during an enrollment process for generating a user representation, in accordance with some implementations.

FIG. 4 is a flowchart illustrating an exemplary method that determines a hand texture for use in providing a 3D representation of a user's hand and/or body, in accordance with some implementations.

FIG. 5 is a block diagram of an electronic device of in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

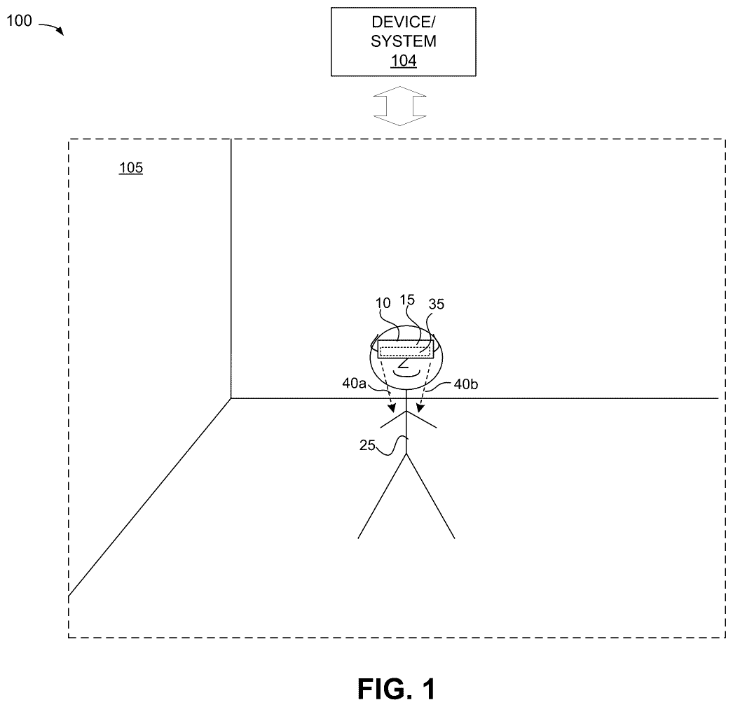

FIG. 1 illustrates an example environment 100 of a real-world environment 105 (e.g., a room) including a device 10 (i.e., an HMD) with a display 15. Additionally, example environment 100 includes a device/system 104 (e.g., a server, an intermediary device, a receiving/viewing device, etc.) in communication with device 10. In some implementations, the device 10 displays content to a user 25.

The device 10 obtains image data, depth data, motion data, tone data, and/or physiological data (e.g., pupillary data, facial feature data, upper-body features, arms, hands (e.g., a back (dorsal) side of a hand and a palm side of the hand), etc.) from the user 25 via a plurality of sensors (e.g., sensors 35). For example, the device 10 may obtain arms and hands (e.g., a tone or color) feature characteristic data 40a and 40b via sensors 35 (e.g., downward facing sensors/cameras of an HMD).

In some implementations, the plurality of sensors (e.g., sensors 35) may include any number of sensors that acquire data relevant to the appearance of the user 25. For example, when wearing a head-mounted device (HMD), one or more sensors (e.g., a camera inside the HMD) may acquire pupillary data for eye tracking and one or more sensors (e.g., sensors 35) may be located on the HMD but on the outside surface of the HMD facing towards the user's head/face/upper body/arms/hands to capture the facial/body feature data (e.g., facial feature characteristic data and/or upper body, arms, hands, etc.) feature characteristic data 40a and 40b).

User data (e.g., facial feature characteristic data, eye gaze characteristic data, and upper body, arms, and hands characteristic data 40a and 40b) may vary in time and the device 10 may use the user data to generate and/or provide a representation of the user.

In some implementations, the user data includes texture data of the facial features such as eyebrow movement, chin movement, nose movement, cheek movement, etc. For example, when a person (e.g., user 25) smiles, facial features can include a plethora of muscle movements that may be replicated by a representation of the user (e.g., an avatar) based on the captured data from sensors 35.

In some implementations, the user data (e.g., hands characteristic data 40a and 40b) includes texture data of the hands of the user such as hand movement, etc. For example, when a person (e.g., user 25) waves associated hand movement can include a plethora of muscle movements that may be replicated by a representation of the user (e.g., an avatar or just hands) based on the captured data from sensors 35.

In some implementations, the device 10 captures user data about the appearance of user 25 and provides that user data (or a 3D user representation derived from that data) to another device so that the other device can render a 3D user representation of the user to a second user. For example, during a communication session, two users may wear HMD devices that transmit to one another user representation data so that each user can view a respective 3D representation of the other user, e.g., with a 3D environment such as a shared XR environment. In some implementations, 3D user representations are presented live (e.g., on device 10 or another device). In some implementations, 3 user representations are recorded (e.g., as 3D videos comprising multiple heightfield and appearance data frames) for later playback.

In some implementations, the device 10 presents an XR environment and/or a graphical user interface (GUI). In some implementations, the user 25 interacts within an XR environment and/or with a GUI. In some implementations, the XR environment and/or GUI provide functions including, but not limited to, image editing, drawing, presenting, word processing, website creating, disk authoring, spreadsheet making, game playing, telephoning, video conferencing, e-mailing, instant messaging, workout support, digital photographing, digital videoing, web browsing, digital music playing, and/or digital video playing. Executable instructions for performing these functions may be included in a computer readable storage medium or other computer program products configured for execution by one or more processors.

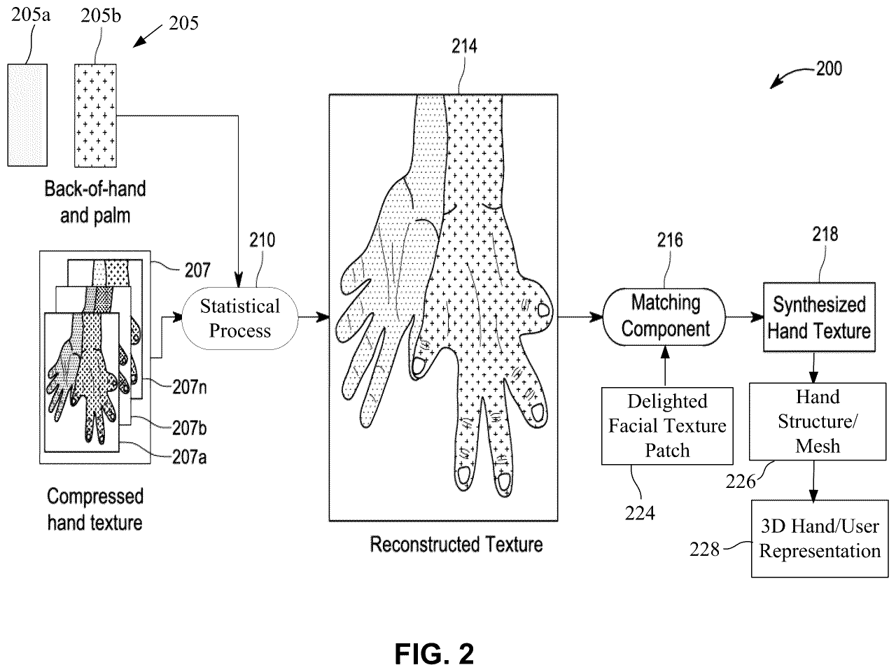

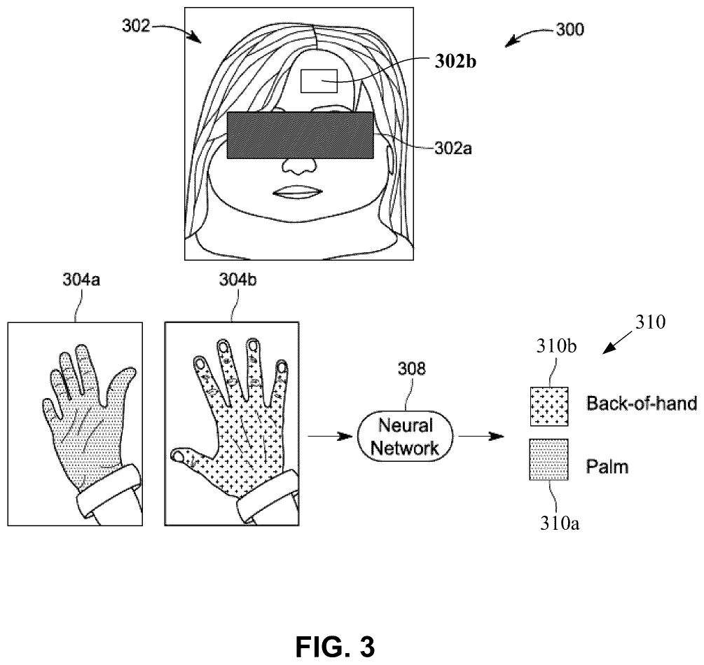

FIG. 2 illustrates an example system 200 that uses skin tone estimation data 205 representing a skin tone of a palm side 205a (e.g., comprising a color(s), comprising multiple region palm samples (taken from various regions of the palm) to characterize the palm with multiple colors, etc.) and a skin tone of a back (dorsal) side 205b (e.g., comprising a color(s), comprising multiple region back (dorsal, opisthenar, etc.) side hand samples (taken from various regions of the back side of the hand) to characterize the palm with multiple colors, etc.) of a hand of a user in combination with (optionally) a delighted facial texture patch 224 (representing a facial tone of the user) and sample hand textures 207 to generate an accurate synthesized hand texture 218 for use in providing a secure and accurate (3D) hand/user representation 228 (e.g., comprising a user's hand, face, and/or body). The synthesized hand texture 218 may be generated during a user enrollment process. The skin tone estimation data 205 and delighted facial texture patch 224 may be generated as described with respect to FIG. 3, infra. Sample hand textures 207 may comprise multiple (e.g., 500) compressed hand textures 207a . . . 207n. The compressed hand textures 207a-207n can be any suitable textures of human hands, such as real hand image scans of hands of multiple individuals differing from the user, synthetically generated images of hands, and the like. Use of sample hand textures 207 to generate a synthesized hand texture 218 may compensate for missing, occluded, and/or inaccurate hand enrollment data (e.g., hand images 304a and 304b captured by one or more image sensors on the electronic device as illustrated with respect to FIG. 3) retrieved during an enrollment process and captured by scene-facing cameras.

Various implementations, for example, may enable any type of statistical process 210 (e.g., numerical optimization) to use skin tone estimation data 205 and sample hand textures 207 to generate and/or lookup a reconstructed texture 214 comprising similarities to skin tone estimation data 205. For example, a hand texture (e.g., reconstructed texture 214) may be reconstructed with respect to a distribution of a hand texture of in a compressed model (e.g., sample hand textures 207) matching a color input.

Various implementations enable an interpolation process to use skin tone estimation data 205 and sample hand textures 207 to generate the reconstructed texture 214.

Some implementations enable a matching component 216 to generate a synthesized hand texture 218 from a delighted facial texture 224 patch (e.g., a patch of facial texture of a face of the user without any effects of lighting) the reconstructed texture 214. The synthesized hand texture 218 comprises a texture based on the delighted facial texture 224 patch and the reconstructed texture 214. The synthesized hand texture 218 may be applied to a hand structure/mesh 226 for use in generating the 3D hand/user representation 228 (e.g., an avatar comprising a hand representation) such that the 3D hand/user representation 228 comprises consistent skin tones with respect to facial skin tones of the actual user. The hand structure/mesh 226 may represent physical attributes (e.g., a bone length) of a hand. The consistent skin tones allow for reducing or eliminating a perception that the hand(s) and face of the user (in the generated user representation) do not belong to a same person. Likewise, the synthesized hand texture 218 may ensure that the synthesized hand texture 218 comprises a skin tone that is accurate with respect to a skin tone of a palm side of a hand of the user.

In some implementations, a principal component analysis (PCA) algorithm, a VAE algorithm, etc. may be executed to compress sample hand textures 207 and remove details of the sample hand textures 207 to preserve sample data privacy of the individuals who provided the sample hand textures and to reduce storage requirements for the sample hand textures. For example, user privacy may be preserved by removing identifying user features from the sample hand textures 207 such as, inter alia, scars, tattoos, fingerprint patterns, etc.

Various implementations may generate a hand structure associated with physical attributes (e.g., a bone length) of a hand of the user to be used in combination with synthesized hand texture 218 to generate a (3D) representation of a hand (e.g., of 3D hand/user representation 228). The synthesized hand texture 218 and the hand structure may be generated during an enrollment process and may be stored for later use such as, inter alia, during live communication session.

During display of a user hand representation, a generated hand texture's pixel values may be mapped to vertices of a 3D hand mesh (which may be based on the hand's current 3D position/configuration) to provide an appearance of the 3D user hand representation. The 3D hand mesh may be based on a current 3D position and/or configuration of a hand of the user. In some implementations, the 3D mesh is modified for the user based on physical attributes (e.g., a bone length) of the hand of the user. For example, a hand tracking system may be configured to determine dimensions of each finger of the hand of the user and the mesh may be warped to fit the user's hand.

Various implementations enable 3D hand/user representation 228 to present a 3D hand(s) representation rendered concurrently with, and positioned with respect to, a 3D head and/or face representation. In some implementations, a single process (e.g., machine learning model such as a trained neural network) is used to produce a representation of both the hand(s) and head/face.

FIG. 3 illustrates an example process 300 using a neural network 308 to estimate a nominal skin tone of a hand(s) of a user regardless of lighting conditions occurring during an enrollment process for capturing data representing the hands of the user for generating a user representation such as an avatar. The skin tone estimation data 205 and delighted facial texture patch 224 (as described with respect to FIG. 2) may be generated as a result of execution of the process 300 of FIG. 3. The process 300 masks out a portion 302a of a face in an image 302. The portion 302a represents an area that will not be used for providing a delighted facial texture patch for generating a synthesized hand texture. The process further receives as an input, a patch 302b (e.g., delighted facial texture patch 224 of FIG. 2) from a de-lighted facial texture, from an area above the eyes but below the hair, of image 302 of a user and hand images 304a and 304b of hands (i.e., a back side and palm side of the hands) of the user to generate (via execution of a skin tone estimation neural network 308) skin tone estimation data 310 (e.g., skin tone estimation data 205 of FIG. 2) representing a skin tone of a palm side 310a (e.g., skin tone of palm side 205a of FIG. 2) and a skin tone of a back (dorsal) side 310b (e.g., skin tone of back side 205b of FIG. 2) of a hand of a user. Patch 302b is generated by masking an upper facial area (of a face of image 302) and extracting a facial skin tone of a region of the face that statistically has suitable light from which to sample skin tones, such as the forehead region, nose bridge region, and the like. Patch 302b may be generated by masking a portion of any facial area of a face of image 302 that statistically has suitable light from which to sample skin tones.

Skin tone estimation neural network 308 is configured to monitor hand images 304a and 304b of hands that may be represented via non-ideal lighting conditions (e.g., lighting conditions during image capture that may have been dim and may have caused a shadow). Therefore, estimation neural network 308 may be trained with respect to real scene-facing sensor data (hand images 304a and 304b) as well as synthetic data (e.g., patch 302a) to analyze hand images 304a and 304b with respect to in the non-ideal lighting conditions and generate as an output, a delighted skin tone representing back side and palm of hand (e.g., skin tone estimation data 310 representing a skin tone of a palm side 310a and a skin tone of a back (dorsal) side 310b of a hand) for use in generating a user representation (e.g., a 3D hand/user representation 228 of FIG. 2) representing a user's hand, face, and/or body.

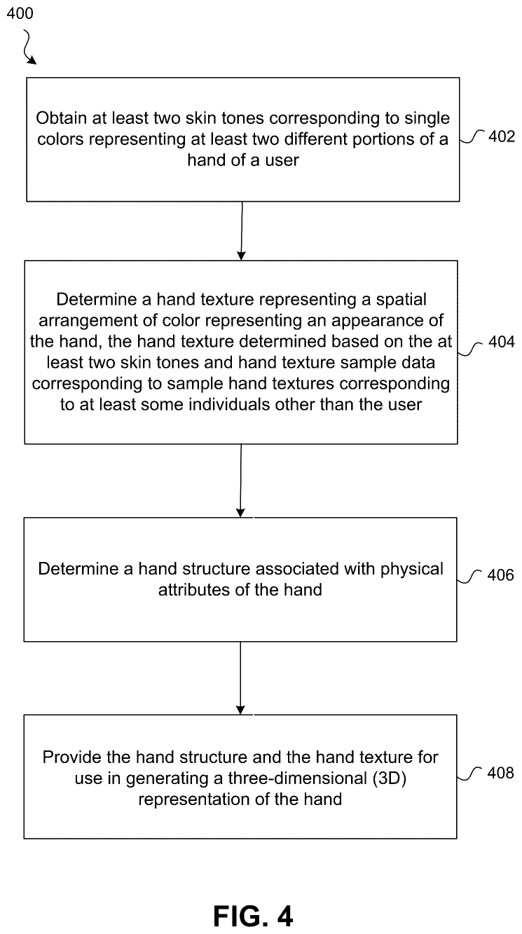

FIG. 4 is a flowchart representation of an exemplary method 400 that determines a hand texture for use in providing a 3D representation of a user's hand and/or body. In some implementations, the method 400 is performed by a device, such as a mobile device (e.g., device 10 of FIG. 1), desktop, laptop, HMD, a server/intermediary device, a receiving/viewing device, etc. In some implementations, the device has a screen for displaying images and/or a screen for viewing stereoscopic images such as a head-mounted display (HMD such as e.g., device 10 of FIG. 1). In some implementations, the method 400 is performed by processing logic, including hardware, firmware, software, or a combination thereof. In some implementations, the method 400 is performed by a processor executing code stored in a non-transitory computer-readable medium (e.g., a memory). Each of the blocks in the method 400 may be enabled and executed in any order.

At block 402, the method 400 obtains at least two skin tones corresponding to color(s) s representing at least two different portions of a hand of a user. For example, the method 400 may obtain a skin tone of palm side 205a of a hand and a skin tone of a back side 205b of a hand as illustrated in FIG. 2. In some implementations, the at least two skin tones comprise a first skin tone (e.g., a color(s)) representing a back portion of the hand of the user and a second skin tone (e.g., a color(s)) representing a palm portion of the hand of the user.

In some implementations, the at least two skin tones are generated based on information representing a portion of a face of the user in combination with images of the hand of the user. In some implementations, determining the at least two skin tones occurs during an enrollment process.

In some implementations, the portion of the face of the user is a patch of facial texture retrieved from delighted face enrollment data.

At block 404, the method 400 determines a hand texture, such as reconstructed texture 214 of FIG. 2, representing a spatial arrangement of color representing an appearance of the hand. The hand texture may be determined based on the at least two skin tones and hand texture sample data corresponding to sample hand textures corresponding to, inter alia, synthetic hand images, at least some individuals other than the user, etc. In some implementations, the spatial arrangement of colors comprise pixels representing multiple colors associated with differing portions of the hand of the user.

In some implementations, determining the hand texture may include selecting a texture from the hand texture sample data via any type of statistical process with respect to the at least two skin tones.

In some implementations, determining the hand texture comprises selecting a texture from the hand texture sample data via an interpolation process with respect to the at least two skin tones.

In some implementations, determining the hand texture may include: compressing the sample hand textures via execution of a principal component analysis (PCA), a VAE, etc.; and removing identifying details (e.g., scars, tattoos, etc.) from the sample hand textures via execution of the PCA or VAE.

In some implementations, the hand texture is determined during an enrollment process and stored for future use. The future use may include a live communication session between the user and an additional user. Alternatively, the future use may include displaying a 3D representation of the user with the 3D representation of the hand.

At block 406, the method 400 determines a hand structure, such as hand structure/mesh 226 as illustrated in FIG. 2, associated with physical attributes (e.g., a bone length) of the hand. In some implementations, pixel values of the hand texture are mapped to vertices of a 3D hand mesh, representing the hand structure, to provide an appearance for the 3D representation of the hand. The vertices of the 3D hand mesh may be based on the current 3D position of the hand.

At block 408, the method 400 provides the hand structure and the hand texture for use in generating a three-dimensional (3D) representation of the hand as a part of 3D hand/user representation 228 as illustrated in FIG. 2. The hand texture and hand structure may be determined during an enrollment process and stored for later use, e.g., during live communication sessions. During display of the user representation, the generated hand texture's pixel values may be mapped to vertices of a 3D hand mesh (which may be based on the hand's current 3D position/configuration) to provide the appearance of the 3D user hand representation.

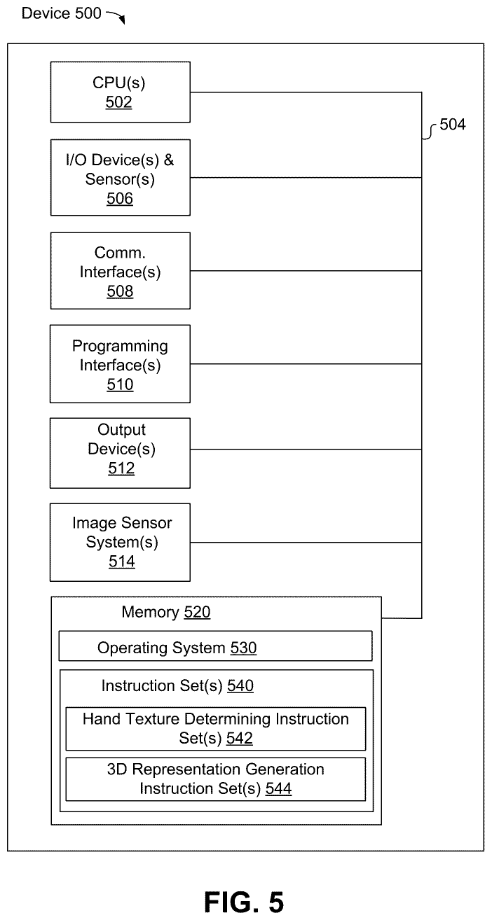

FIG. 5 is a block diagram of an example device 500. Device 500 illustrates an exemplary device configuration for electronic device of FIG. 1. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 500 includes one or more processing units 502 (e.g., microprocessors, ASICs, FPGAs, GPUs, CPUs, processing cores, and/or the like), one or more input/output (I/O) devices and sensors 504, one or more communication interfaces 508 (e.g., USB, FIREWIRE, THUNDERBOLT, IEEE 802.3x, IEEE 802.11x, IEEE 802.14x, GSM, CDMA, TDMA, GPS, IR, BLUETOOTH, ZIGBEE, SPI, I2C, and/or the like type interface), one or more programming (e.g., I/O) interfaces 510, output devices (e.g., one or more displays) 512, one or more interior and/or exterior facing image sensor systems 514, a memory 520, and one or more communication buses 504 for interconnecting these and various other components.

In some implementations, the one or more communication buses 504 include circuitry that interconnects and controls communications between system components. In some implementations, the one or more I/O devices and sensors 505 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), one or more cameras (e.g., inward facing cameras and outward facing cameras of an HMD), one or more infrared sensors, one or more heat map sensors, and/or the like.

In some implementations, the one or more displays 512 are configured to present a view of a physical environment, a graphical environment, an extended reality environment, etc. to the user. In some implementations, the one or more displays 512 are configured to present content (determined based on a determined user/object location of the user within the physical environment) to the user. In some implementations, the one or more displays 512 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 512 correspond to diffractive, reflective, polarized, holographic, etc. waveguide displays. In one example, the device 500 includes a single display. In another example, the device 500 includes a display for each eye of the user.

In some implementations, the one or more image sensor systems 514 are configured to obtain image data that corresponds to at least a portion of the physical environment 100. For example, the one or more image sensor systems 514 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 514 further include illumination sources that emit light, such as a flash. In various implementations, the one or more image sensor systems 514 further include an on-camera image signal processor (ISP) configured to execute a plurality of processing operations on the image data.

In some implementations, sensor data may be obtained by device(s) (e.g., device 10 of FIG. 1) during a scan of a room of a physical environment. The sensor data may include a 3D point cloud and a sequence of 2D images corresponding to captured views of the room during the scan of the room. In some implementations, the sensor data includes image data (e.g., from an RGB camera), depth data (e.g., a depth image from a depth camera), ambient light sensor data (e.g., from an ambient light sensor), and/or motion data from one or more motion sensors (e.g., accelerometers, gyroscopes, IMU, etc.). In some implementations, the sensor data includes visual inertial odometry (VIO) data determined based on image data. The 3D point cloud may provide semantic information about one or more elements of the room. The 3D point cloud may provide information about the positions and appearance of surface portions within the physical environment. In some implementations, the 3D point cloud is obtained over time, e.g., during a scan of the room, and the 3D point cloud may be updated, and updated versions of the 3D point cloud obtained over time. For example, a 3D representation may be obtained (and analyzed/processed) as it is updated/adjusted over time (e.g., as the user scans a room).

In some implementations, sensor data may be positioning information, some implementations include a VIO to determine equivalent odometry information using sequential camera images (e.g., light intensity image data) and motion data (e.g., acquired from the IMU/motion sensor) to estimate the distance traveled. Alternatively, some implementations of the present disclosure may include a simultaneous localization and mapping (SLAM) system (e.g., position sensors). The SLAM system may include a multidimensional (e.g., 3D) laser scanning and range-measuring system that is GPS independent and that provides real-time simultaneous location and mapping. The SLAM system may generate and manage data for a very accurate point cloud that results from reflections of laser scanning from objects in an environment. Movements of any of the points in the point cloud are accurately tracked over time, so that the SLAM system can maintain precise understanding of its location and orientation as it travels through an environment, using the points in the point cloud as reference points for the location.

In some implementations, the device 500 includes an eye tracking system for detecting eye position and eye movements (e.g., eye gaze detection). For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user. Moreover, the illumination source of the device 500 may emit NIR light to illuminate the eyes of the user and the NIR camera may capture images of the eyes of the user. In some implementations, images captured by the eye tracking system may be analyzed to detect position and movements of the eyes of the user, or to detect other information about the eyes such as pupil dilation or pupil diameter. Moreover, the point of gaze estimated from the eye tracking images may enable gaze-based interaction with content shown on the near-eye display of the device 500.

The memory 520 includes high-speed random-access memory, such as DRAM, SRAM, DDR RAM, or other random-access solid-state memory devices. In some implementations, the memory 520 includes non-volatile memory, such as one or more magnetic disk storage devices, optical disk storage devices, flash memory devices, or other non-volatile solid-state storage devices. The memory 520 optionally includes one or more storage devices remotely located from the one or more processing units 502. The memory 520 includes a non-transitory computer readable storage medium.

In some implementations, the memory 520 or the non-transitory computer readable storage medium of the memory 520 stores an optional operating system 530 and one or more instruction set(s) 540. The operating system 530 includes procedures for handling various basic system services and for performing hardware dependent tasks. In some implementations, the instruction set(s) 540 include executable software defined by binary information stored in the form of electrical charge. In some implementations, the instruction set(s) 540 are software that is executable by the one or more processing units 502 to carry out one or more of the techniques described herein.

The instruction set(s) 540 includes a hand texture determining instruction set 542 and a 3D representation generation instruction set 544. The instruction set(s) 540 may be embodied as a single software executable or multiple software executables.

The hand texture determining instruction set 542 is configured with instructions executable by a processor to determine a hand texture representing a spatial arrangement of color representing an appearance of the hand.

The 3D representation generation instruction set 544 is configured with instructions executable by a processor to produce 3D representations of a hand of a user based on a determined hand structure and hand texture.

Although the instruction set(s) 540 are shown as residing on a single device, it should be understood that in other implementations, any combination of the elements may be located in separate computing devices. Moreover, FIG. 5 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

Those of ordinary skill in the art will appreciate that well-known systems, methods, components, devices, and circuits have not been described in exhaustive detail so as not to obscure more pertinent aspects of the example implementations described herein. Moreover, other effective aspects and/or variants do not include all of the specific details described herein. Thus, several details are described in order to provide a thorough understanding of the example aspects as shown in the drawings. Moreover, the drawings merely show some example embodiments of the present disclosure and are therefore not to be considered limiting.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, e.g., one or more modules of computer program instructions, encoded on computer storage medium for execution by, or to control the operation of, data processing apparatus. Alternatively, or additionally, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel. The operations described in this specification can be implemented as operations performed by a data processing apparatus on data stored on one or more computer-readable storage devices or received from other sources.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at an electronic device having a processor:
obtaining at least two skin tones corresponding to colors representing at least two different portions of a hand of a user;
determining a hand texture comprising a spatial arrangement of color representing an appearance of the hand, the hand texture determined based on the at least two skin tones and hand texture sample data;
determining a hand structure associated with physical attributes of the hand; and
providing the hand structure and the hand texture for use in generating a three-dimensional (3D) representation of the hand.

2. The method of claim 1, wherein the at least two skin tones comprise a first skin tone representing a back portion of the hand of the user and a second skin tone representing a palm portion of the hand of the user.

3. The method of claim 1, wherein the at least two skin tones are generated based on information representing a portion of a face of the user in combination with images of the hand of the user.

4. The method of claim 3, wherein said determining the at least two skin tones occurs during an enrollment process, and wherein the portion of the face of the user is a patch of facial texture retrieved from delighted face enrollment data.

5. The method of claim 1, wherein the spatial arrangement of color comprises pixels representing multiple colors associated with differing portions of the hand of the user.

6. The method of claim 1, wherein said determining the hand texture comprises selecting a texture from the hand texture sample data via a statistical process with respect to the at least two skin tones.

7. The method of claim 1, wherein said determining the hand texture comprises selecting a texture from the hand texture sample data via an interpolation process with respect to the at least two skin tones.

8. The method of claim 1, wherein said determining the hand texture comprises:
compressing the sample hand textures via execution of a principal component analysis (PCA); and
remove identifying details from the sample hand textures via execution of the PCA.

9. The method of claim 1, wherein the hand texture is determined during an enrollment process and stored for future use.

10. The method of claim 9, wherein the future use comprises a live communication session between the user and an additional user.

11. The method of claim 9, wherein the future use comprises displaying a 3D representation of the user with the 3D representation of the hand.

12. The method of claim 1, wherein pixel values of the hand texture are mapped to vertices of a 3D hand mesh, representing the hand structure, to provide an appearance for the 3D representation of the hand.

13. The method of claim 12, wherein the vertices of a 3D hand mesh are based on the current 3D position of the hand.

14. The method of claim 1, wherein the hand texture sample data corresponds to sample hand textures corresponding to at least some individuals other than the user.

15. The method of claim 1, wherein the at least two skin tones are determined based on one or more images of the hand and a face of the user.

16. The method of claim 1, wherein the hand structure and the attributes are determined during an enrollment process, and wherein dimensions of hand texture are modified and applied to the hand structure for said generating the 3D representation of the hand based on the attributes.

17. An electronic device comprising:
a non-transitory computer-readable storage medium; and
one or more processors coupled to the non-transitory computer-readable storage medium, wherein the non-transitory computer-readable storage medium comprises program instructions that, when executed on the one or more processors, cause the device to perform operations comprising:
obtaining at least two skin tones corresponding to colors representing at least two different portions of a hand of a user;
determining a hand texture representing a spatial arrangement of color representing an appearance of the hand, the hand texture determined based on the at least two skin tones and hand texture sample data;
determining a hand structure associated with physical attributes of the hand; and
providing the hand structure and the hand texture for use in generating a three-dimensional (3D) representation of the hand.

18. The electronic device of claim 17, wherein the at least two skin tones comprise a first skin tone representing a back portion of the hand of the user and a second skin tone representing a palm portion of the hand of the user.

19. The electronic device of claim 17, wherein the at least two skin tones are generated based on information representing a portion of a face of the user in combination with images of the hand of the user.

20. A non-transitory computer-readable storage medium storing program instructions executable via one or more processors, of an electronic device, to perform operations comprising:
obtaining at least two skin tones corresponding to colors representing at least two different portions of a hand of a user;
determining a hand texture representing a spatial arrangement of color representing an appearance of the hand, the hand texture determined based on the at least two skin tones and hand texture sample data;
determining a hand structure associated with physical attributes of the hand; and
providing the hand structure and the hand texture for use in generating a three-dimensional (3D) representation of the hand.
